(19) United States
(12) Patent Application Publication
(10) Pub. No.: US 2008/0220310 A1
(43) Pub. Date: Sep. 11, 2008

(54) Protection for Anode-Supported High-Temperature Fuel Cells Against Reoxidation of the Anode

(75) Inventors: Josef Mertens, Alsdorf (DE); Norbert Menzler, Juelich (DE); Hans Peter Buchkremer, Heinsberg (DE); Detlev Stoever, Niederzier (DE)

Correspondence Address: JORDAN AND HAMBURG LLP, 122 EAST 42ND STREET, SUITE 4000, NEW YORK, NY, 10168, US

(73) Assignee: Forschungszentrum Juelich GmbH, Juelich (DE)

(21) Appl. No.: 11/990,409

(22) PCT Filed: Aug. 5, 2006
(86) PCT No.: PCT/DE2006/001374

§ 371 Date: Apr. 7, 2008

(30) Foreign Application Priority Data
Aug. 18, 2005 (DE) 10 2005 039 442.6

(51) Int. Cl. H01M 8/02; H01M 8/10

(52) U.S. Cl. 429/33

(57) ABSTRACT

Anode-supported high-temperature fuel cells with a substrate and an anode of stabilised zirconium dioxide and metallic nickel can be destroyed by air penetrating on the fuel gas side. Reoxidation causes the volume of the nickel in the anode to change. The resultant mechanical stresses may destroy the gas-impermeable electrolyte. The invention provides oxygen scavengers that can be produced at low cost for the anode, which more effectively bind the oxygen that penetrates on the fuel gas side than oxygen scavengers according to the prior art.

### BACKGROUND OF THE INVENTION

The invention relates to a device for protecting the anode of an anode-supported solid oxide fuel cell against reoxidation.

A solid oxide fuel cell (SOFC) comprises a porous anode, a gas-tight but oxygen ion-conducting electrolyte, and a porous cathode. A fuel gas, for instance hydrogen or methane, is supplied to the anode. An oxidizing agent, for instance air or pure oxygen, is supplied to the cathode. Oxygen ions from the oxidizing agent are conducted through the electrolyte into the anode, where they oxidize the fuel gas. In addition to heat, electrons that can feed an external electrical consumer are also produced. Since one individual fuel cell provides only a small voltage, normally a plurality of cells are switched together to create a fuel cell stack.

Anode, cathode, and electrolyte can each be thin layers, but they can also be designed with greater solidity so that they provide the fuel cell with mechanical stability. In this case, they are called anode-supported, cathode-supported, or electrolyte-supported cells.

The substrate and the anode of an anode-supported solid oxide fuel cell frequently have a cermet made of stabilized zirconium dioxide and metallic nickel, the nickel being the electrochemically active component. Particulate nickel oxide (NiO) is used for the starting material when producing the substrate and the anode. It is reduced to metallic nickel when the cell is first started up. It is disadvantageous that the nickel reoxidizes as soon air penetrates the cell on the fuel gas side, approximately when the stack is started up or shut down. The volume of the resultant nickel oxide is greater than the original volume of the NiO particles used initially [Lit 1]. This results in stresses in the structure of the substrate and anode materials, which generally deteriorate due to the formation of cracks. Due to the high stresses the electrolyte can also crack, rendering the fuel cell unusable. This problem even occurs when the electrolyte is under residual compressive stress for production reasons.

Disadvantages result from the sensitivity of solid oxide fuel cells to reoxidation, in particular, when the fuel cell is used for generating power in a vehicle. During the typically lengthy standing times overnight and on the weekend it is usually not possible to prevent air from diffusing in on the anode side. Moreover, there are air impurities on the fuel gas side on the part of the reformer due to the system. External devices such as, for instance, non-return valves incur additional costs, increase weight, and require room for installation.

The problems related to reoxidation can be mitigated in that a different electrically conducting material, such as, for instance, copper, or an electrically conducting ceramic is used instead of nickel. It is a disadvantage that in the past it has not been possible to find a true alternative to nickel. In addition to electrical conductivity, critical for the usability of a conductive material in a fuel cell are catalytic activity, resistance under reducing conditions, and the smallest possible reactivity with other components of the fuel cell.

In order to minimize the force transmitted from the anode to the electrolyte, the cell can be produced with an electrolyte-supported or cathode-supported structure. Electrolyte-supported cells have the disadvantage that due to the high Ohmic losses in the solid electrolyte they require a much higher operating temperature (approximately 1000° C. instead of approximately 800° C. for anode-supported cells) and their power density is comparatively low. Cathode-supported cells are more expensive to produce than anode-supported cells since Perovskite cathode material is more expensive than anode material.

Metallic bearing structures can be attached to the anode side in order to absorb some of the forces exerted by the anode material. It is disadvantageous that these bearing structures reduce the power density of the cell and can themselves be susceptible to reoxidation, so that they can warp in a manner similar to the anode. Thus, they can themselves contribute to the formation of cracks.

The metallic nickel in the anode can be coated with an oxide phase in order to protect an interior thereof from reoxidation. It is disadvantageous that this reduces the electrical conductivity of the nickel and thus the power output of the cell.

Known from US 2003 0235752 A1 and U.S. Pat. No. 6,744,235 B2 are oxygen scavengers in the form of a foam, wire, or knit made of nickel or a nickel alloy for the fuel gas lines to and from the anode of a solid oxide fuel cell. They are primarily oxidized by penetrating air and then reduced again when the cell is started up again. However, it is disadvantageous that these oxygen scavengers have only low reaction efficiency and are comparatively expensive to produce.

The object of the invention is therefore to provide a device for protecting the substrate and/or the anode of an anode-supported solid oxide fuel cell, which device can be produced in a cost-effective manner and offers better protection against reoxidation than oxygen scavengers from the prior art.

### SUMMARY OF THE INVENTION

This object is attained in accordance with the invention using a fuel cell stack with oxygen scavenger.

In the framework of the invention, it was found that an oxygen scavenger for a solid oxide fuel cell can be created based on a temperature-stable, inert ceramic basic material. The basic material is modified with a small amount of active material that is able to bond oxygen. The porous basic material provides a large surface for the reaction so that the reaction efficiency is increased relative to the prior art. Only a small volume of active material is required relative to this surface, which is in particular advantageous when the active material is a surface reactant. Since the active materials are significantly more expensive than the basic material, an oxygen scavenger according to the invention is more cost-effective to create than an oxygen scavenger according to the prior art.

In one advantageous embodiment of the invention, stabilized or unstabilized zirconium dioxide, aluminum oxide, stabilized or unstabilized ceroxide, carbon silicide, or silicon nitride are used for the basic material. These materials are particularly temperature stable.

Metallic nickel as active material has the advantage that it is already used in the anode of the fuel cell. This simplifies manufacture. In particular the material combination with zirconium oxide as the basic material represents a common material as the material for solid oxide fuel cells.

For instance, the oxygen scavenger can be a cermet made of yttrium-stabilized zirconium oxide and metallic nickel and thus can be exactly the same as the anode material. Anode and oxygen scavenger can thus be produced using the same industrial production process. During operation, due to the always recurring reduction and reoxidation such an oxygen scavenger can also develop cracks like an anode exposed to oxygen with no protection. However, since it is porous and is neither coupled mechanically to the gas-tight electrolyte nor assumes an electrochemical function, this does not have a negative effect on its functionality, nor can it cause cell failure. According to the prior art, any contact the anode material has with oxygen is problematic. However, in the framework of the invention, it was recognized that the anode material can be protected with an oxygen scavenger made of anode material prior to contact with oxygen.

The active material can be disposed on the surface of the basic material after it has been applied there for instance by vapor deposition. The material can also be disposed in the surface of the basic material, that is, intercalated, after the surface has been, for instance, impregnated with the active material. This has the advantage of better adhesion between active material and basic material. However, the active material can also be intercalated in the pores of the basic material, which advantageously further enlarges the surface that can be used for the oxygen bonding. These embodiments can be combined with one another in any desired manner. Combinations advantageously lead to an even larger surface with active material and thus to even greater reaction efficiency.

The basic material can advantageously be a nonwoven, knitted fabric, interlaced yarn, fiber mat, paste, sponge, or bulk powder. This further increases its porosity. The active material with which the basic material is modified thus obtains an even larger surface that can be used for the oxygen bonding.

In the framework of the invention it was furthermore found that it is also possible to obtain markedly better reaction efficiency using an active material in powder form, having a grain size between 50 μm and 100 μm, than can be obtained with oxygen scavengers from the prior art. Given a powder having a grain size of 100 μm, there is 50% more surface area for the oxygen bonding, and given a grain size of 50 μm, there is 100% more surface area for the oxygen bonding, than for a wire made of active material with an equivalent wire thickness and the same material weight according to the prior art.

The powder can preferably be enclosed in a cage so that it can be exchanged easily if its effectiveness is irreversibly compromised. However, it can also be present in a bulk form that the fuel gas must pass over. The advantage of a bulk powder is that due to the loose bulk matter there is enough free volume available for increasing the volume through reoxidation and thus no damaging mechanical force is exerted on the surroundings.

The active material can be selected from the group nickel, cobalt, zinc, tin, vanadium, chromium, manganese, iron, molybdenum, titanium, cadmium, and silicon. It should be noted that, for instance, titanium and silicon bind the oxygen very strongly and cannot be further reduced with fuel gas. These materials are thus not reversible. Other materials, such as nickel, cobalt, or iron, can be reduced with fuel gas again after oxidation. These materials thus regenerate the next time the fuel cell is started up after the air has penetrated. The amount of active material required depends on the kinetics of oxidation and reduction of the material in question and on the number and frequency of the reaction cycles that occur during operation and should be calculated by one skilled in the art or determined in a reasonable number of tests. A third material group advantageously has at least two oxidation stages, such as, for instance, iron with ferrous oxide and ferric oxide. Other advantageous representatives of this group are divanadium trioxide, dichromium monoxide, manganese monoxide, iron monoxide, and diiron trioxide. During oxidation and reduction the volume of these materials changes less sharply than pure metals, so that mechanical stressing of the oxygen scavenger during operation can be reduced.

The following describes a method in which the inventive fuel cell stack is used, and that protects the substrate or the anode of the solid oxide fuel cells from reoxidation when air penetrates on the fuel gas side, as can occur for example when starting up or shutting down the fuel cell. In the first step of this method the penetrating oxygen is bonded using an oxygen scavenger according to the invention. Its absorption capacity is limited, however. So that the fuel cell is not subjected to further penetrating oxygen with no protection after the active material has been exhausted, during or after the penetration of the air, the fuel cell is brought to an operating condition in which the anode no longer continues to reoxidize appreciably, even in the presence of air. The phrase “No longer . . . appreciably” shall, in particular, be construed to mean that stresses in the anode material no longer occur in a measure that jeopardizes the electrolyte. In particular, the fuel cell can advantageously be cooled rapidly from it normal operating temperature of about 800° C. to less than about 600° C. to protect from reoxidation. At this temperature, the reaction kinetics of the nickel contained in the anode are already very slow. Moreover, “no longer . . . appreciably” can be construed to mean reoxidation of less than or equal to 0.10 mol 1/2 O₂/mol Ni.

The phrase “rapid cooling” shall, in particular, be construed to mean cooling that occurs more rapidly than the passive removal of residual heat from the fuel cell after the fuel gas supply has been cut off. In particular, during a planned power reduction in the fuel cell, the temperature can be reduced as quickly as possible by 200° C. or more using additional measures for removing heat. Such accelerated cooling can occur, in particular, by means of drawing off heat using a ventilator or by supplying a coolant.

A suitable device is advantageously used to monitor the fuel cell stack during operation for potential air penetration on the fuel gas side. Thus, with another suitable device, the fuel cell stack can be automatically brought to a reoxidation-stable operating condition when air penetration occurs. This ensures that the anode is protected from reoxidation even when the fuel cells experience an unplanned reduction in power, for instance, due to an interruption in the fuel gas supply.

It was found in the framework of the invention that, in accordance with the invention, an oxygen scavenger can be integrated into a fuel cell stack as the first level. In this form, the oxygen scavenger requires particularly little space for installation, especially if only one oxygen scavenger is required for all of the fuel cells in the stack. It is particularly simple to produce a fuel cell stack with such an oxygen scavenger when a material is used for the oxygen scavenger that is exactly the same as the anode material. Then, its mechanical dimensions can also be selected such that they correspond to those of an anode. Thus the same production line can be used for producing the oxygen scavenger that is used to produce the anode, as well.

The subject-matter of the invention is described in greater detail using illustrations, but this shall not limit the subject-matter of the invention.

### BRIEF DESCRIPTION OF THE DRAWINGS

FIG. 1 depicts a fuel cell stack having an oxygen scavenger as the first level; and

FIG. 2 depicts a fuel cell stack having an oxygen scavenger integrated into the fuel gas supply.

### DETAILED DESCRIPTION OF THE INVENTION

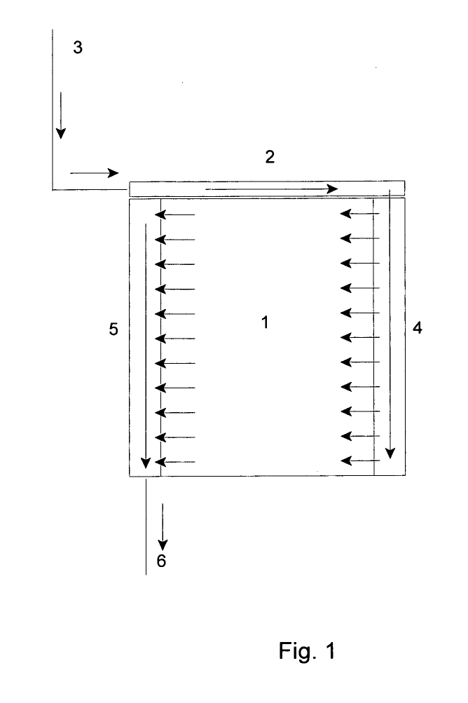

FIG. 1 depicts a fuel cell stack 1 in which an oxygen scavenger 2 is integrated as the first level between the gas supply 3 and the gas distribution structures 4. The fuel gas necessarily flows past this level first before it is diverted at the end of the level and conducted into the fuel cells on the other levels of the stack. Oxygen contained in the fuel gas reacts on the surface of the oxygen scavenger and does not reach the fuel cells. The rest of the fuel gas and the exhaust gas are collected in the gas collection units 5 and leave the fuel cell stack at the position 6. The arrows indicate the direction of flow of the fuel gas.

The oxygen scavenger inventively comprises, for instance, a bulk powder or even a porous base material with an active coating.

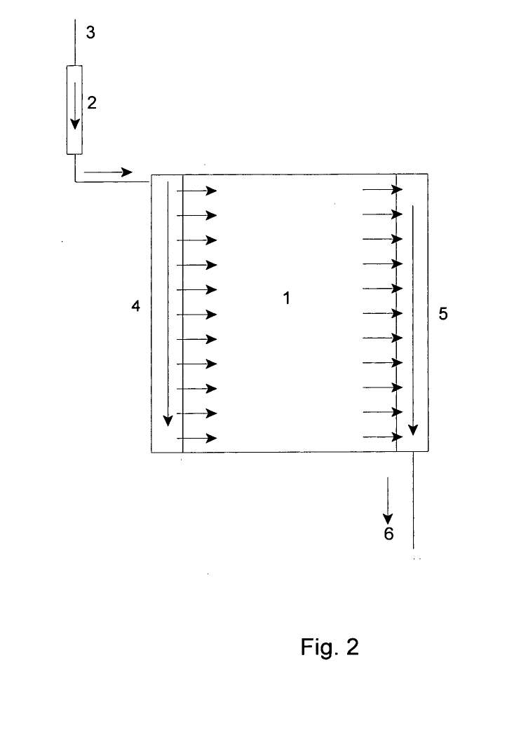

FIG. 2 depicts an alternative arrangement in which the actual fuel cell stack 1 remains unchanged. An enlargement is added to the fuel gas supply line 3, and the oxygen scavenger 2 is integrated therein. The fuel gas is conducted through the fuel cell stack via the gas distribution structures 4. Unburned fuel gas and exhaust gas are collected in the gas collection units 5 and leave the fuel cell stack at the position 6. The arrows indicate the direction of flow of the fuel gas.

In this arrangement, the porosity of the oxygen scavenger is selected such that the loss in pressure due to the scavenger is not too great, because otherwise the flow conditions in the stack would change. The bulk powder can also be used in a cage instead of the porous component.

1.-11. (canceled)

12. A fuel cell stack, comprising
a series of levels including fuel cells, each of said fuel cells including a substrate and an anode suppliable with a fuel gas by a fuel gas supply; and
an oxygen scavenger arranged as one of the levels which is located between the fuel gas supply and other ones of the levels occupied by the fuel cells for protecting the substrate and/or the anode of the fuel cells, said oxygen scavenger including a temperature-stable, inert ceramic basic material having a porous structure and an oxygen-bonding active material that includes at least one element selected from the group consisting of cobalt, zinc, tin, vanadium, chromium, manganese, iron, molybdenum, titanium, cadmium, nickel, and silicon.

13. A fuel cell stack according to claim 12, wherein said basic material of the oxygen scavenger includes a substance selected from the group consisting of stabilized zirconium dioxide, unstabilized zirconium dioxide, aluminum oxide, stabilized ceroxide, unstabilized ceroxide, carbon silicide, and silicon nitride.

14. A fuel cell stack according to claim 12, wherein the active material of the oxygen scavenger is disposed on a surface of the basic material.

15. A fuel cell stack according to claim 12, wherein the active material of the oxygen scavenger is intercalated in a surface of the basic material.

16. A fuel cell stack according to claim 12, wherein the active material of the oxygen scavenger is intercalated in pores of the basic material of the oxygen scavenger.

17. A fuel cell stack according to claim 12, wherein the basic material of the oxygen scavenger is present in the form of a nonwoven, knit, knit fabric, fiber mat, paste, sponge, or bulk powder.

18. A fuel cell stack, comprising
a series of levels including fuel cells, each of said fuel cells including a substrate and an anode suppliable with a fuel gas by a fuel gas supply; and
an oxygen scavenger arranged as one of the levels which is located between the fuel gas supply and other ones of the levels occupied by the fuel cells for protecting the substrate and/or the anode of the fuel cells, the oxygen scavenger including an oxygen-bonding active material which includes at least one element selected from the group consisting of cobalt, zinc, tin, vanadium, chromium, manganese, iron, molybdenum, titanium, cadmium, nickel, and silicon, and which is present as a powder having a grain size between 50 μm and 100 μm.

19. A fuel cell stack according to claim 18, further comprising a cage in which the powder is enclosed.

20. A fuel cell stack according to claims 18, wherein said powder is present in bulk form.

21. A fuel cell stack according to claim 12, wherein at least one higher oxidation level is assumable by said active material during oxidation.

22. A fuel cell stack according to claim 18, wherein at least one higher oxidation level is assumable by said active material during oxidation.

23. A fuel cell stack according to claim 21, wherein said active material includes V₂O₃, Cr₂O, MnO, FeO, or Fe₂O₃.

24. A fuel cell stack according to claim 22, wherein said active material includes V₂O₃, Cr₂O, MnO, FeO, or Fe₂O₃.
